(19) United States
(12) Patent Application Publication
(10) Pub. No.: US 2026/0311666 A1
(43) Pub. Date: Oct. 8, 2026

(54) MUSIC ACCOMPANIMENT GENERATION METHOD AND APPARATUS, DEVICE, STORAGE MEDIUM AND PROGRAM PRODUCT

(71) Applicant: Guangzhou Kugou Computer Technology Co., Ltd., Guangzhou, Guangdong (CN)

(72) Inventors: Yue Yang, Guangzhou, Guangdong (CN); Huiyi Cheng, Guangzhou, Guangdong (CN); Chengfang Luo, Guangzhou, Guangdong (CN); Chuanyi Chen, Guangzhou, Guangdong (CN)

(21) Appl. No.: 19/480,311

(22) PCT Filed: Dec. 6, 2024
(86) PCT No.: PCT/CN2024/137646

§ 371 Date: Jan. 16, 2026

(30) Foreign Application Priority Data
Dec. 27, 2023 (CN) 202311824499.3

(51) Int. Cl. G10H 1/00; G10H 1/38

(52) U.S. Cl. CPC G10H 1/0025; G10H 1/38; G10H 2210/005; G10H 2210/056; G10H 2210/066; G10H 2210/076; G10H 2210/111; G10H 2210/125; G10H 2210/571

(57) ABSTRACT

Provided is a method for generating musical accompaniment, including: acquiring musical data, wherein the musical data is divided into at least two musical beats, each of the musical beats comprising musical notes; extracting beat data information, chord data information, and melody data information from the musical data; generating musical accompaniment data based on the melody data information, the beat data information, and the chord data information; and obtaining musical accompaniment corresponding to the musical data by performing audio data rendering based on the musical accompaniment.

### CROSS-REFERENCE TO RELATED APPLICATIONS

The present disclosure is a U.S. national phase application based on PCT/CN2024/137646. filed on Dec. 6, 2024, which claims priority to Chinese Patent Application No. 202311824499.3, filed on Dec. 27, 2023 and entitled “METHOD AND APPARATUS FOR GENERATING MUSICAL ACCOMPANIMENT, DEVICE, STORAGE MEDIUM, AND PROGRAM PRODUCT”, both of which are incorporated by reference herein.

### TECHNICAL FIELD

Embodiments of the present disclosure relate to the field of computer technologies, and in particular, relate to a method and apparatus for generating musical accompaniment, a device, a storage medium, and a program product.

### BACKGROUND

Art creation has long been considered the exclusive field of artists. However, with the development of computer technologies in recent years, art creation has gradually broken down its traditional barriers. With the help of computer technologies, music compositions can be created manually, allowing for greater improvement in terms of both music types and content.

### SUMMARY

Embodiments of the present disclosure provide a method and apparatus for generating musical accompaniment, a device, a storage medium, and a program product. The technical solutions are as follows.

In one aspect, a method for generating musical accompaniment is provided. The method is performed by a computer device. The method includes:
acquiring musical data, wherein the musical data is divided into at least two musical beats, each of the musical beats including musical notes;
extracting beat data information, chord data information, and melody data information from the musical data, wherein the beat data information is configured to describe a variation speed of the at least two musical beats, the chord data information is configured to describe a chord unit extracted in a unit of the musical beat, and the melody data information is configured to describe a note variation between at least two musical notes;
generating musical accompaniment data based on the melody data information, the beat data information, and the chord data information, wherein the melody data information is configured to define an accompaniment melody of the musical accompaniment with a musical melody of the musical data, and the musical accompaniment data is configured to describe accompaniment of the musical data; and
obtaining musical accompaniment corresponding to the musical data by performing audio data rendering based on the musical accompaniment data.

In another aspect, an apparatus for generating musical accompaniment is provided. The apparatus includes:
a data acquisition module, configured to acquire musical data, wherein the musical data is divided into at least two musical beats, each of the musical beats including musical notes;
an information extraction module, configured to extract beat data information, chord data information, and melody data information from the musical data, wherein the beat data information is configured to describe a variation speed of the at least two musical beats, the chord data information is configured to describe a chord unit extracted in a unit of the musical beat, and the melody data information is configured to describe a note variation between at least two musical notes;
a data generation module, configured to generate musical accompaniment data based on the melody data information, the beat data information, and the chord data information, wherein the melody data information is configured to define an accompaniment melody of the musical accompaniment with a musical melody of the musical data, and the musical accompaniment data is configured to describe accompaniment of the musical data; and
an accompaniment generation module, configured to obtain musical accompaniment corresponding to the musical data by performing audio data rendering based on the musical accompaniment data.

In another aspect, a computer device is provided. The computer device includes a processor and a memory storing at least one program, wherein the at least one program, when loaded and executed by the processor, causes the processor to perform the method for generating the musical accompaniment as defined in any one of the above embodiments of the present disclosure.

In another aspect, a computer-readable storage medium is provided. The computer-readable storage medium stores at least one program, wherein the at least one program, when loaded and executed by a processor, causes the processor to perform the method for generating the musical accompaniment as defined in any one of the above embodiments of the present disclosure.

In another aspect, a computer program product or computer program is provided. The computer program product includes one or more computer programs stored in a computer-readable storage medium. The one or more computer programs, when read from the computer-readable storage medium by a processor of a computer device and executed by the processor, cause the computer device to perform the method for generating the musical accompaniment as defined in any one of the above embodiments of the present disclosure.

### BRIEF DESCRIPTION OF DRAWINGS

FIG. 1 is a schematic diagram of an implementation environment according to some exemplary embodiments of the present disclosure;

FIG. 2 is a flowchart of a method for generating musical accompaniment according to some exemplary embodiments of the present disclosure;

is a flowchart of a method for generating musical accompaniment according to some other exemplary embodiments of the present disclosure;

FIG. 4 is a flowchart of a method for generating musical accompaniment according to yet some other exemplary embodiments of the present disclosure;

FIG. 5 is a flowchart of a method for generating musical accompaniment according to still some other exemplary embodiments of the present disclosure;

FIG. 6 is a schematic diagram of an overall framework of a method for generating musical accompaniment according to some exemplary embodiments of the present disclosure;

FIG. 7 is a schematic input diagram of a method for generating accompaniment according to some exemplary embodiments of the present disclosure;

FIG. 8 is a processing flowchart of a method for generating musical accompaniment according to some exemplary embodiments of the present disclosure;

FIG. 9 is a schematic diagram of piano numbered musical notation according to some exemplary embodiments of the present disclosure;

FIG. 10 is a structural block diagram of an apparatus for generating musical accompaniment according to some exemplary embodiments of the present disclosure; and

FIG. 11 is a structural block diagram of a computer device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

First, the terms involved in the embodiments of the present disclosure are briefly described hereinafter.

Symbol domain: In music theory, a symbol domain refers to the range of symbols or numerical values used by a computer in the case of processing music, that is, the symbol domain refers to a music format read and processed by a computer in a generation process being a digital music format. In the digital music format, music elements such as notes, pitches, and volumes are typically represented in a digital form. For example, the digital music format is implemented as a musical instrument digital interface (MIDI) format, a music extensible markup language (MusicXML) format, or the like. For example, MIDI uses numbers to represent notes, pitches, volumes, and other music parameters. In a MIDI file, different numerical values represent different notes, and the velocity of a note may be represented by a number. The symbol domain may include, for example, a note value (a number representing a note value; for example, 4 represents a quarter note, 8 represents an eighth note, and the like), pitch (the pitch of a note is represented using a number or code, and each note in MIDI has a corresponding pitch value), and a volume (a volume level of a note or a musical instrument is represented in a digital form, and a large numerical value typically represents a high volume). These numbers or symbols constitute a symbol domain used by a computer in a music generation process. The computer can read, process, and generate music through these symbols. In this context, the definition of the symbol domain involves the scope and method in which numbers represent music elements.

Piano cover: A piano cover refers to the adaptation and performance of the original music in an audio format with vocals and complete accompaniment in the form of a piano piece.

In the related art, if it is desired to generate corresponding music accompaniment based on music, a deep learning-based method is typically adopted for accompaniment generation. A model is trained using sample music and corresponding sample accompaniment, so that the model learns the method for generating accompaniment. Then, the music for which the accompaniment needs to be generated is input into the trained model to obtain the music accompaniment. The above process excessively relies on the precise correspondence between the sample music and the sample accompaniment. Although the method can generate good music accompaniment to a certain extent, it ignores the inherent music theory information of the music. This easily leads to a large gap between the musical style of the music accompaniment and the music itself, affecting the accuracy of the music accompaniment in a musical context.

In the embodiments of the present disclosure, a method for generating musical accompaniment is introduced. According to the method, musical beats and musical notes can be quantized through a musical information extraction process, improving the analysis precision of musical data; further, at least two pieces of quantitative information are integrated, and beats and chords are incorporated into the process of generating an accompaniment melody under the definition of a musical melody, so that musical accompaniment data can be presented in more detail through music parameters, thereby improving the generation stability and the generation effect of the musical accompaniment. The method for generating the musical accompaniment may be applied to the fields of music production, music creation, game production, advertisement production, virtual reality (VR), augmented reality (AR), and the like, which is not limited in the embodiments of the present disclosure.

It should be noted that the information (including but not limited to user device information, user personal information, and the like), data (including but not limited to data for analysis, stored data, displayed data, and the like), and signals involved in the present disclosure are authorized by the user or fully authorized by various parties, and the collection, use, and processing of the relevant data are required to comply with relevant laws and regulations and standards in relevant regions. For example, the content such as musical data and musical information extraction involved in the present disclosure is all acquired under sufficient authorization.

Next, the implementation environment involved in the embodiments of the present disclosure is described. The method for generating the musical accompaniment according to the embodiments of the present disclosure may be implemented by a terminal device alone, or may be implemented by a server, or may be implemented by a terminal device and a server through data interaction, which is not limited in the embodiments of the present disclosure. In some embodiments, an example in which the terminal device and the server interactively perform the method for generating the musical accompaniment is used for description.

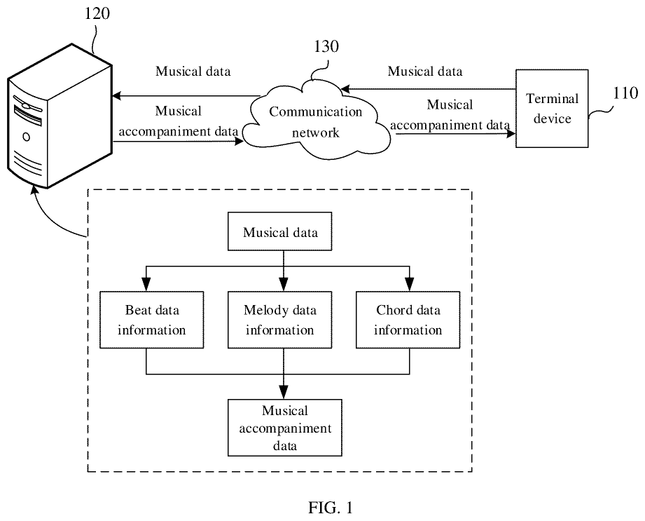

In some embodiments, referring to FIG. 1, a terminal device 110 and a server 120 are involved in the implementation environment, and the terminal device 110 and the server 120 are connected through a communication network 130.

In some embodiments, the terminal device 110 features a function of collecting musical data and obtains musical data through methods such as recording and manual production. For example, a song is used as the musical data.

In some embodiments, the terminal device 110 transmits musical data to the server 120 through the communication network 130, and the server 120 obtains the musical data. The musical data is divided into at least two musical beats, each musical beat including musical notes.

In some embodiments, the server 120 extracts beat data information, chord data information, and melody data information from the musical data.

The beat data information is configured to represent the variation speed of the at least two musical beats, the chord data information is configured to describe a chord unit extracted in a unit of the musical beat, and the melody data information is configured to describe the note variation between at least two musical notes.

In some embodiments, the server 120 generates musical accompaniment data through the beat data information and the chord data information with the melody data information as a generation restriction condition for the musical accompaniment.

The melody data information is configured to define an accompaniment melody of the musical accompaniment with a musical melody of the musical data, and the musical accompaniment data is configured to describe the accompaniment of the musical data. The melody data information, as the musical melody content presenting the whole musical data, is beneficial to playing an overall definition effect in the process of generating the musical accompaniment, so that on the basis that the accompaniment melody is defined by the musical melody, the musical accompaniment data with higher precision is generated through the beat speed represented by the beat data information and local musical notes represented by the chord data information.

In some embodiments, the server 120 obtains musical accompaniment corresponding to the musical data by performing audio data rendering based on the musical accompaniment data.

The musical accompaniment data, as the accompaniment described by music parameters, is music data content presented in the form of a symbol domain. Therefore, in the case that the musical accompaniment corresponding to the musical data needs to be acquired, it is necessary to perform audio data rendering on the musical accompaniment data, thereby obtaining the musical accompaniment to be played. For example, the musical accompaniment data is analyzed by specific audio data decoding software, thereby obtaining the musical accompaniment presented by performing audio data rendering on the musical accompaniment data.

In some embodiments, the server 120 transmits the musical accompaniment data to the terminal device 110 through the communication network, so that the terminal device 110 performs audio data rendering on the musical accompaniment data to obtain the musical accompaniment. Alternatively, the server performs audio data rendering on the musical accompaniment data to obtain an accompaniment data file that is convenient for the terminal device to directly play, and transmits the accompaniment data file to the terminal device 110 through the communication network, so that the terminal device 110 downloads and plays the musical accompaniment based on the accompaniment data file.

It should be noted that the terminal device includes, but is not limited to, a mobile terminal device such as a mobile phone, a tablet computer, a portable laptop computer, an intelligent voice interaction device, a smart home appliance, or a vehicle-mounted terminal device, or may be implemented as a desktop computer or the like. The server may be an independent physical server, or may be a server cluster or a distributed system formed by at least two physical servers, or may be a cloud server.

In some embodiments, the server is also implemented as a node in a blockchain system.

The computer device in the present disclosure may be at least one of the terminal device 110 or the server 120, which is not limited in the present disclosure. Each step in the following embodiments is performed by a computer device.

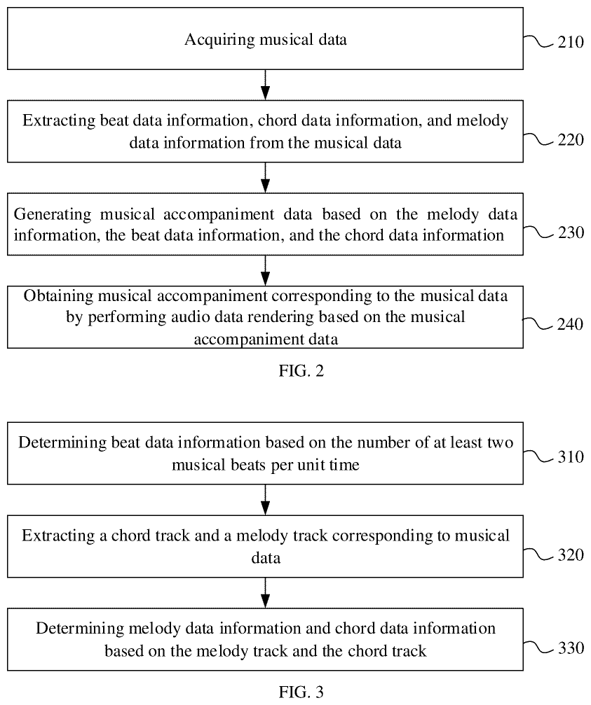

The method for generating the musical accompaniment according to the present disclosure is described in combination with the above term introduction and application scenarios. An example in which the method is applicable to the above computer device is used for description. As shown in FIG. 2, the method includes at least one of the following steps 210 to 240.

In step 210, musical data is acquired.

In some embodiments, the musical data refers to data represented in the form of audio, which is configured to contain the actual audio content of music.

In some embodiments, the musical data is stored in a format such as a waveform audio file format (WAV), a moving picture experts group audio layer III (MP3), or a free lossless audio codec (FLAC), and is configured to play music content as acoustic wave signals are included therein.

For example, the musical data may be implemented as a vocal song, such as an album music sung by a singer, a song sung by an individual, or a song hummed by an individual. The musical data may also be implemented as a program of a radio station, a television program, a news broadcast, or the like. The musical data may also be implemented as a concert recording or a vocal concert recording. The musical data may also be implemented as a telephone recording or the like.

The musical data is divided into at least two musical beats, each musical beat including musical notes.

In some embodiments, the musical beat is a basic organizational element in the music, and the musical beat determines the temporal arrangement and emphasis of the musical notes. The musical beat is the content capable of expressing the sense of time of the music, and a piece of music typically consists of alternating strong beats and weak beats. The contrast between strong and weak musical beats creates the sense of rhythm of the musical data. In different music styles and cultures, the use and emphasis of the musical beat may be different. The musical beat is one of the important means for the creator to express the music emotion and convey the music information.

In some embodiments, the musical beat is a unit of time in a time signature; each time signature features a strong beat (typically the first beat), and the other time signatures are referred to as weak beats. As a symbol representing a music rhythm on a music score, the time signature consists of two numbers. The upper number represents the number of time signatures per measure, and the lower number represents the value of each time signature, wherein the value represents the duration of the musical note in the musical beat. For example, a 4/4 time signature means that there are four time signatures per measure, each time signature being referred to as the time length of one quarter note.

That is, the musical beat is a basic unit of time in music, and musical notes included therein determine music information in the unit of time. Within a time signature, musical notes of different values can be accommodated, and the combination and arrangement of these notes form the rhythm of a musical piece.

In step 220, beat data information, chord data information, and melody data information are extracted from the musical data.

In some embodiments, the musical information extraction is configured to quantize the musical data to present the musical data presented in the form of audio in the form of data. In some embodiments, the beat data information, the chord data information, and the melody data information are extracted from the musical data by musical information extraction. In some embodiments, the beat data information, the chord data information, and the melody data information separately corresponding to the musical data are acquired by quantizing the musical data. In addition, the extraction method is not limited to quantization, and the beat data information, the chord data information, and the melody data information may alternatively be extracted using a trained neural network model.

In some embodiments, the musical information extraction is performed on the musical data, so that the beat data information representing the rhythm variation of the musical data is acquired, the chord data information representing different chords in the musical data is also acquired, and the melody data information representing the overall melody variation of the musical data is also acquired.

That is, the beat data information is configured to represent the variation speed of the at least two musical beats, the chord data information is configured to describe a chord unit extracted in a unit of the musical beat, and the melody data information is configured to describe the note variation between at least two musical notes.

In some embodiments, as a basic unit of time in the musical data, the musical beat creates the basic rhythm structure of the musical data and defines the order of musical notes on the time axis. In the case that the musical beat is represented by a time signature, the number of time signatures per measure and the value of each time signature are specified. In the case of acquiring the beat data information, at least two musical beats corresponding to the musical data may be determined first, and then the beat data information may be determined based on the distribution variation of the at least two musical beats.

In some embodiments, the chord is a set of at least two notes played simultaneously and is arranged in a fixed interval relationship. The chord is the basis of harmony in music and is very important for creating and emphasizing the sense of harmony. The chord may include musical notes such as the fundamental note, the third note, and the fifth note, thereby forming different harmonic textures. That is, the chord focuses on the combination of simultaneous notes with an emphasis on representing pitch relationships in the vertical direction. In the case of acquiring the chord data information, musical notes in each musical beat may be determined in a unit of the musical beat, and then the musical audio is grouped into chords (or referred to as chord units).

In some embodiments, the melody consists of a series of organically related notes, which are played in chronological order to form a music expression with melody cues. The melody is the combination of pitch and value and is the most recognizable and most easily remembered part of music, typically consisting of a main melody and a secondary melody. That is, the melody focuses on the combination of pitch and value in the horizontal direction. In the case of acquiring the melody data information, the focus is on pitch variations respectively corresponding to the at least two musical notes and values respectively corresponding to the at least two musical notes, thereby comprehensively determining the melody data information corresponding to the musical data.

In a piece of musical data, three elements of a beat, a chord, and a melody are typically interleaved with each other, jointly creating a complex and interesting music experience. The time frame is provided by the musical beat, the harmony basis is provided by the chord, and musical guidance cues are given by the melody, thereby presenting the musical data in more detail.

With the help of the musical information extraction process, the musical beat is quantized into the beat data information, the chord is quantized into the chord data information, and the melody is quantized into the melody data information, so as to analyze the musical data based on at least two pieces of quantized information after information extraction.

In step 230, musical accompaniment data is generated based on the melody data information, the beat data information, and the chord data information.

In some embodiments, after obtaining the melody data information, the overall melody of the musical data is represented based on the melody data information. Therefore, with the melody data information as a generation restriction condition, the musical accompaniment corresponding to the musical data is generated within the musical melody represented by the melody data information.

That is, the melody data information is configured to define an accompaniment melody of the musical accompaniment with a musical melody of the musical data.

In some embodiments, the musical melody is configured to represent a series of organically related musical notes, which are played in chronological order to form a music expression with melody cues, and belongs to the most recognizable and most easily remembered part of the musical data. The melody data information refers to a number, a symbol, or a computer-readable form representing a melody and includes a pitch sequence, value information, note duration, and the like. In addition, the melody data information is typically encoded in the form of a number or symbol and is information for computer analysis, music generation, or other digital music processing tasks. That is, the melody data information has a corresponding relationship with the musical melody, and the melody data information is the digital form of the musical melody.

Similarly, the accompaniment melody is configured to represent a series of organically related musical notes, which are played in chronological order to form musical accompaniment with melody cues. Therefore, the accompaniment melody corresponding to the musical accompaniment is defined by the musical melody corresponding to the melody data information with the melody data information as the generation restriction condition for the musical accompaniment.

The musical accompaniment data describes the accompaniment of the musical data by music parameters. The music parameter herein refers to parameters related to music, such as at least one of tone, intonation, or velocity.

In some embodiments, the musical accompaniment data has a corresponding relationship with the accompaniment melody, and the musical accompaniment data is the digital form of the accompaniment melody. In the case that the musical accompaniment data is generated through the beat data information and the chord data information, the musical accompaniment data corresponding to the accompaniment melody is generated. As the digital form corresponding to the accompaniment melody, the musical accompaniment data is generated by describing the accompaniment of the musical data through numerous music parameters.

The musical accompaniment is not only related to the musical melody corresponding to the musical data, but also related to the chords and the beats. Therefore, in the case of generating the musical accompaniment data, the musical accompaniment data is expressed by music parameters related to the melody such as pitch, value, and instrument, music parameters related to the chord such as pitch and harmony, and also music parameters related to the beat such as volume and rhythm mode. That is, the music parameters for describing the accompaniment of the musical data include various parameter contents related to the musical accompaniment such as pitch, instrument, volume, rhythm mode, and harmony part.

In step 240, musical accompaniment corresponding to the musical data is obtained by performing audio data rendering based on the musical accompaniment data.

In some embodiments, after obtaining the musical accompaniment data, based on the musical accompaniment data being the digital form corresponding to the musical accompaniment, the musical accompaniment data is decoded to present the musical accompaniment data in the form of audio. That is, audio data rendering is performed on the musical accompaniment data, thereby obtaining the musical accompaniment corresponding to the musical data.

In some embodiments, the musical accompaniment data is implemented in the form of a digital representation, i.e., a MIDI file, which describes the musical data. In the case that the musical accompaniment corresponding to the musical accompaniment data needs to be acquired, the MIDI file includes music information such as notes, pitches, and values, but does not include sound waveforms, and thus, the MIDI file needs to be converted into accompaniment data for rendering the obtained musical accompaniment. That is, audio conversion is first performed based on the musical accompaniment data to obtain accompaniment audio; audio rendering is performed on the accompaniment audio to obtain the musical accompaniment.

In some embodiments, the method for performing the audio conversion on the musical accompaniment data to obtain the accompaniment data includes the following steps.
(1) Software tool: The MIDI file is converted into accompaniment data using specialized music production software or a MIDI editor. The MIDI editor is implemented as Ableton Live, Fruity Loops Studio (FL Studio), Logic Pro, Fluid Synth, Timidity++, or the like.
(2) Virtual musical instrument or sound source: A virtual musical instrument or sound source plug-in is selected or loaded in the foregoing software. These plug-ins act as virtual musical instruments, capable of generating corresponding audio waveforms from the information in the MIDI file.
(3) MIDI file connection: The MIDI file is imported into the software, usually by dragging and dropping the file or using an import function. The MIDI file includes information such as a note, pitch, and the value of music.
(4) Instrument assignment: An appropriate instrument is assigned to the MIDI file or note, and it is determined which musical instrument is used to simulate the note in the MIDI file. The process is typically done in the interface of a virtual musical instrument or sound source plug-in.
(5) Rendering into audio: The MIDI file is rendered into an audio file, usually WAV, MP3, an audio interchange file format (AIFF), or the like, by using an “export” or “rendering” function of preset software. The preset software generates corresponding audio waveforms based on the MIDI file.
(6) Effect adjustment: An audio effect, reverb, an equalizer, and the like, may be added to software as required to adjust the final effect of audio.

It should be noted that in the above conversion process of converting the MIDI file into the accompaniment audio, the sound quality and expressiveness depend on the quality of the virtual musical instrument or sound source used. Some professional virtual musical instrument libraries provide high-quality instruments and realistic audio generation. With the help of the above process, the music information in the MIDI file can be converted into an audio format (accompaniment audio) recognizable by a computer, so that the accompaniment audio is turned on on a computer or other audio devices for the purpose of playing music.

In some embodiments, the accompaniment audio after the audio conversion is rendered to obtain the musical accompaniment. For example, the accompaniment audio is turned on by the terminal device, thereby playing the musical accompaniment or the like.

It should be noted that the above are only examples given in some embodiments, which are not limited in the embodiments of the present disclosure.

In summary, the beat data information, the chord data information, and the melody data information are extracted from the acquired musical data; the musical accompaniment data is generated through the beat data information and the chord data information with the melody data information as the generation restriction condition, and finally, the musical accompaniment is obtained by rendering the musical accompaniment data. In the process of generating the musical accompaniment data through the musical data, the musical beats and the musical notes are quantized through a musical information extraction process, improving the analysis precision of the musical data, so that the process of generating the accompaniment data is more targeted. In addition, beats and chords are incorporated into the process of generating the accompaniment melody under the definition of the musical melody by integrating the melody data information, the beat data information, and the chord data information, so that the musical accompaniment data can be presented in more detail through music parameters, and then the musical accompaniment of the musical data obtained by rendering the musical accompaniment data is more precise, thereby improving the generation stability and the generation effect of the musical accompaniment.

In some embodiments, the beat data information is determined based on the number of the at least two musical beats per unit time, and the melody data information and the chord data information respectively corresponding to the musical data are acquired through a melody track and a chord track, thereby improving the data acquisition efficiency and accuracy. In some embodiments, as shown in FIG. 3, step 220 shown in FIG. 2 is also implemented as at least one of the following steps 310 to 330.

In step 310, the beat data information is determined based on the number of the at least two musical beats per unit time.

In some embodiments, the unit time is a preset unit duration. For example, the unit time is one minute, or half a minute, or five seconds.

In some embodiments, data beat information corresponding to the musical data is expressed in beat per minute (BPM). BPM is a unit used for representing a rhythm speed in music, and is configured to represent the number of time signatures per minute. In the process of determining the BPM, one can calculate it manually or rely on tools such as music production software. For example, during manual calculation, in the case that the rhythm of music can be felt, a watch or a timer may be used to determine the number of time signatures in one minute. For example, in the case that a count is 120 in one minute, the BPM is 120. Alternatively, a music beat detector is used to determine the BPM, and the BPM of a song may be displayed.

In step 320, a chord track and a melody track corresponding to the musical data are extracted.

The chord track is configured to describe a tone cluster constructed in the form of a chord by the at least two musical notes having a temporal relationship.

In some embodiments, the chord track is a function in music production software for representing chord progress in music.

In some embodiments, the chord track is typically segmented into measures for better organization and understanding of the structure of music. The number of measures of the chord track depends on the structure and arrangement of the music; in music production software, the chord can be created and edited on the chord track, with each measure typically corresponding to one measure in music, thereby helping to maintain consistent chord progress throughout the track and facilitating the adjustment and organization of the music.

The melody track is configured to describe a main melody formed by the at least two musical notes according to a temporal relationship.

In some embodiments, in music production software, the melody track is a concept in music production that refers to an audio track or track including a main melody. The main melody is the most prominent and noticeable melodic line in music, typically performed by musical instruments or singing (such as vocal singing). In music production software, a producer can record, edit, and arrange a main melody using the melody track.

As an audio track for accommodating a main melody, the melody track may record the most important and most easily remembered melodic line in the musical data. The main melody is one of the key elements in music that attract the attention of listeners. Through the melody track, the producer can accurately shape and control the core elements of music, thereby creating works with a unique style and emotion.

In some embodiments, the chord track is also typically segmented into measures. The number of measures of the melody track depends on the structure of the music, the arrangement, and the producer's creative style.

In step 330, the melody data information and the chord data information are determined based on the melody track and the chord track.

In some embodiments, the chord data information is obtained by adjusting the number of measures in the chord track by taking the number of measures in the melody track as a reference; the melody data information is obtained by performing melody transformation on the melody track based on note pitches respectively corresponding to the at least two musical notes in the melody track.

In some embodiments, the number of measures in the melody track and the number of measures in the chord track are respectively determined to obtain a first number corresponding to the melody track and a second number corresponding to the chord track.

The first number is configured to represent the number of measures in the melody track; that is, the melody track includes the first number of measures. The second number is configured to represent the number of measures in the chord track; that is, the chord track includes the second number of measures.

In some embodiments, the melody track and the chord track are typically each segmented into measures; the first number of measures is obtained after the melody track is segmented into measures; and the second number of measures is obtained after the chord track is segmented into measures.

In some embodiments, a music feature extraction model is obtained in advance. The music feature extraction model is a pre-trained model and is configured to perform an analysis process on features such as musical beat, chord, and melody of the musical data. The music feature extraction model is used to separately extract measures from the melody track and the chord track, thereby obtaining the first number of measures in the melody track and the second number of measures in the chord track.

In some embodiments, the first number is equal to the second number, or the first number is different from the second number. For example, the first number is less than the second number, or the second number is less than the first number.

In some embodiments, the second number of the chord track is adjusted by taking the first number as a reference to obtain an adjusted chord track as the chord data information.

In some embodiments, in response to the second number being less than the first number, a filling operation is performed on the chord track based on the first number to obtain a filled chord track as the chord data information. The filled chord track is the above-mentioned adjusted chord track.

In some embodiments, in the case that the second number is less than the first number, it means that the number of measures obtained after the measure division of the chord track is small, and the number of measures obtained after the measure division of the melody track is large. Based on the melody track, the overall effect of the musical data is better represented, so that the filling operation is performed on the second number by taking the first number corresponding to the melody track as a reference, thereby obtaining the filled chord track as the chord data information.

In some embodiments, during the filling operation, by copying the chord of the previous measure of the measure to be filled in the chord track, the filled chord track is obtained as the chord data information.

In some embodiments, each measure in the filled chord track is detected. To avoid an excessive rest in the accompaniment, in the case that there is a measure without any chord, the chord of the previous measure is copied; in the case that the measure is the first measure, the chord of the first subsequent measure that is not a whole rest is copied.

In some embodiments, in response to the second number being equal to the first number, the chord track is used as the chord data information; in response to the second number being greater than the first number, an alignment operation is performed on the melody track and the chord track to obtain an aligned chord track corresponding to the melody track as the chord data information.

In some embodiments, based on note pitches respectively corresponding to the at least two musical notes in the melody track, melody transformation processing is performed on the melody track to obtain an updated melody track as the melody data information.

In some embodiments, the melody track describes note features respectively corresponding to the at least two musical notes, and the pitch is a basic and important concept in music, which determines the relative highness or lowness of musical notes.

In some embodiments, for some songs with generally low-pitched melodies, the melody is selectively transposed an octave higher to improve the listening experience while preventing conflict with the accompaniment.

According to the technical solutions provided in the embodiments of the present disclosure, the number of measures in the chord track is adjusted based on the number of measures in the melody track, so that the chord track is filled, and finally chord data information corresponding to the filled chord track is obtained. Through the note pitch of the musical note in the melody track, melody transformation processing is performed on the melody track, so that the melody is more harmonious, and finally the melody data information is obtained. The method is beneficial for ensuring the accuracy of the acquired chord data information and melody data information.

In some embodiments, a preset first pitch and a preset second pitch are acquired; the first pitch and the second pitch are configured to define a transformation method for performing the melody transformation on the melody track. Exemplarily, the first pitch is a preset low pitch, and the second pitch is a preset high pitch. That is, the preset low pitch and the preset high pitch are acquired. Exemplarily, the first pitch and the second pitch correspond to different pitch numerical values, and the first pitch is lower than the second pitch.

The preset low pitch and the preset high pitch are configured to comprehensively define the processing method for performing the melody transformation processing on the melody track.

In some embodiments, a first note ratio and a second note ratio are determined by comparing the note pitches respectively corresponding to the at least two musical notes in the melody track with the first pitch and the second pitch, respectively, where the first note ratio is configured to represent the note ratio of a first note to the at least two musical notes, the first note being configured to represent a musical note lower than the first pitch, and the second note ratio is configured to represent the note ratio of a second note to the at least two musical notes, the second note being configured to represent a musical note higher than the second pitch; the melody data information is obtained by performing the melody transformation on the melody track based on the first note ratio and the first-second note ratio.

In some embodiments, the first note ratio is also referred to as a bass note ratio in the following embodiments. In some embodiments, the second note ratio is also referred to as a treble note ratio in the following embodiments.

In some embodiments, the first note is also referred to as a bass note in the following embodiments. In some embodiments, the second note is also referred to as a treble note in the following embodiments.

In some embodiments, note pitches respectively corresponding to the at least two musical notes in the melody track are compared with a preset low pitch, and note pitches respectively corresponding to the at least two musical notes are compared with a preset high pitch, to determine the bass note ratio and the treble note ratio.

The bass note ratio is configured to represent the note ratio of a bass note to the at least two musical notes, the bass note being configured to represent a musical note lower than the preset low pitch; the treble note ratio is configured to represent the note ratio of a treble note to the at least two musical notes, the treble note being configured to represent a musical note higher than the preset high pitch.

In some embodiments, melody transformation processing is performed on the melody track based on the bass note ratio and the treble note ratio to obtain an updated melody track as the melody data information.

In some embodiments, after acquiring the melody track, note pitches respectively corresponding to the at least two musical notes are determined; the preset low pitch and the preset high pitch are acquired, and the at least two musical notes are separately compared with the preset low pitch and the preset high pitch to calculate the bass note ratio and the treble note ratio, respectively.

For example, taking the preset low pitch being 56 and the preset high pitch being 70 as an example, after determining the note pitches respectively corresponding to the at least two musical notes, the pitches of the at least two musical notes are separately compared with 56 and 70. In the case that a note pitch corresponding to a musical note is lower than 56, it is considered that the musical note is a bass note; in the case that a note pitch corresponding to a musical note is higher than 70, it is considered that the musical note is a treble note. Therefore, the first note number of bass notes and the second note number of treble notes can be determined; then, the bass note ratio is determined by integrating the first note number and the musical note number of the musical notes, and the treble note ratio is determined by combining the second note number and the musical note number.

In some embodiments, in the case that both the bass note ratio and the treble note ratio meet a preset condition, the melody track is not adjusted.

For example, in the case that the treble note ratio is greater than 10% and the bass note ratio is less than 20%, the melody track is not transposed an octave higher; and in the case that the preset condition is not met, the melody track is adjusted.

In some embodiments, to enable the completeness and the sense of cadence of the music, a coda is added to each musical piece, with the length ranging from one measure to three measures. Different musical melodies end with different measures, some ending with a sustained note, others featuring a long rest, while some lack sufficient time for an added coda. Therefore, it is necessary to determine in advance whether to add a coda measure to the accompaniment track based on the melody track.

In some embodiments, in the case that the last note of the ending measure of the melody track ends after the second beat and is not a sustained note, an empty coda measure is added in advance during the generation of the accompaniment track, and the chord is copied from the chord of the previous measure; thus, during the texture conversion of the coda, in the case that the selected texture exceeds four beats, it will be extended to two or three measures in the case that the MIDI is written.

In some embodiments, the melody data information and the chord data information are obtained based on the melody track and the chord track through the above process, and the melody data information and the chord data information are configured to express the musical data in a digital form by integrating the beat data information.

According to the technical solutions provided in the embodiments of the present disclosure, the preset low pitch and the preset high pitch are compared with note pitches respectively corresponding to the at least two musical notes in the melody track, thereby obtaining the treble note ratio and the bass note ratio in the musical notes. Different melody processing methods are adopted based on different note ratios, which reflects the flexibility and targeting of melody processing, thereby improving the efficiency and precision of determining the melody data information.

It should be noted that the above are only examples given in some embodiments, which are not limited in the embodiments of the present disclosure.

In summary, the beat data information, the chord data information, and the melody data information are extracted from the acquired musical data; the musical accompaniment data is generated through the beat data information and the chord data information with the melody data information as the generation restriction condition, and finally, the musical accompaniment is obtained by rendering the musical accompaniment data. In the process of generating the musical accompaniment data through the musical data, the musical beats and the musical notes are quantized through a musical information extraction process, improving the analysis precision of the musical data, so that the process of generating the accompaniment data is more targeted. In addition, beats and chords are incorporated into the process of generating the accompaniment melody under the definition of the musical melody by integrating the melody data information, the beat data information, and the chord data information, so that the musical accompaniment data can be presented in more detail through music parameters, and then the musical accompaniment of the musical data obtained by rendering the musical accompaniment data is more precise, thereby improving the generation stability and the generation effect of the musical accompaniment.

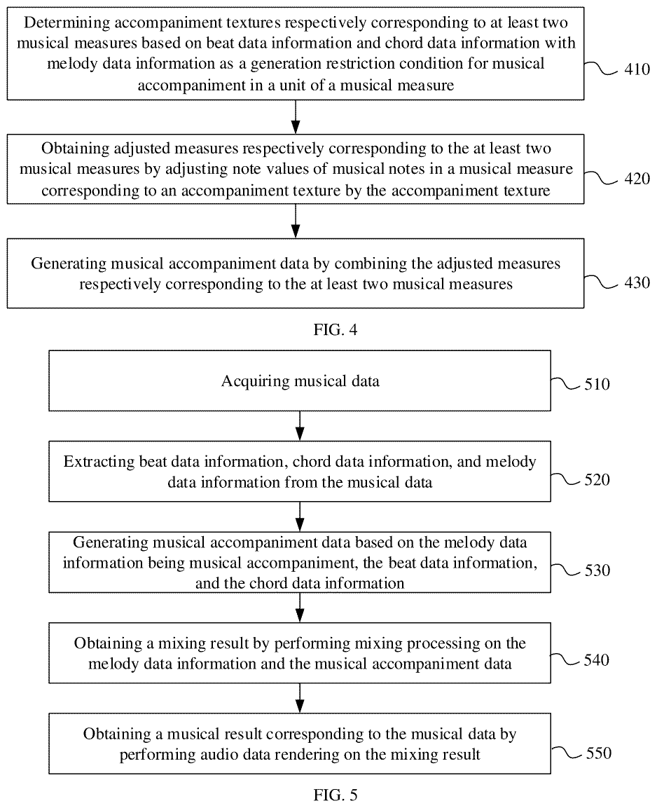

In some embodiments, accompaniment textures respectively corresponding to at least two musical measures in the musical data are acquired first, and then corresponding musical measures are adjusted based on the accompaniment textures, thereby generating the musical accompaniment data by integrating at least two adjusted musical measure combinations. In some embodiments, as shown in FIG. 4, step 230 shown in FIG. 2 is also implemented as the following steps 410 to 430.

In step 410, accompaniment textures respectively corresponding to at least two musical measures are determined based on the beat data information and the chord data information with the melody data information as a generation restriction condition for the musical accompaniment in a unit of a musical measure.

The musical measure, also referred to as a measure, includes a preset number of musical beats. The musical measure is a basic organizational unit for performing refined analysis on the musical data and is configured to divide and organize music segments. The measure is introduced to analyze the musical data, so as to improve the understanding of the musical measure.

The term “in a unit of a musical measure” means that the musical data is analyzed for each musical measure. For each musical measure, the accompaniment texture is determined comprehensively based on the beat data information and the chord data information with the melody data information as the generation restriction condition for the musical accompaniment.

The accompaniment texture is a sound element configured to support and highlight a main melody corresponding to the melody data information. In some embodiments, the accompaniment texture refers to a sound layer in a musical piece that is responsible for supporting and highlighting a main melody. The layer generally includes elements such as chord, bass, drumbeat, and percussion, the combination of which forms the basis and background of the music. The function of the accompaniment texture in music is to provide support for the main melody and add depth and richness to the music. The reasonable use of the accompaniment texture can enable the music to be more complete and rich, and enhance the audience's musical experience. Different types of music may feature different accompaniment texture construction methods to adapt to different styles and emotional expressions.

In some embodiments, accompaniment textures respectively corresponding to at least two musical measures are determined to adjust the musical notes in the musical measures through the accompaniment textures, thereby enriching the expression forms of the musical measures. Further, the musical accompaniment data obtained by combining adjusted measures corresponding to the musical measures is more diverse, which reflects the diversity and flexibility of the method for generating the musical accompaniment.

In some embodiments, in the case of determining the accompaniment texture, the melody, the beat, and the chord are integrated for overall adjustment, so as to determine an accompaniment texture that is convenient for improving the music performance effect of the musical measure.

In some embodiments, a texture determination rule is acquired in a unit of the musical measure.

The texture determination rule is configured to determine an accompaniment texture corresponding to a musical measure through a musical information extraction result.

In some embodiments, the musical information extraction result is configured to represent a result extracted through a musical information extraction process, and the musical information extraction result includes at least one of the melody data information, the beat data information, or the chord data information.

That is, the acquired texture determination rule is configured to determine an accompaniment texture corresponding to a musical measure by integrating the melody data information, the beat data information, and the chord data information in the musical measure.

In some embodiments, the accompaniment textures respectively corresponding to the musical measures are determined by defining the note variation range of the musical accompaniment through the melody data information, defining the rhythm variation of the musical accompaniment through the beat data information, and defining the degree of note coordination of the musical accompaniment through the chord data information under the definition of the texture determination rule.

In some embodiments, the melody data information is closely related to the musical note. Therefore, the pitch, variation, and the like of accompaniment notes in the musical accompaniment are determined with the assistance of the melody data information; that is, the note variation range of the musical accompaniment is defined by the melody data information.

In some embodiments, the melody data information is configured to define a note variation range corresponding to the musical accompaniment through a pitch range, a pitch density, and a pitch value (such as the pitch value of the lowest note).

In some embodiments, the beat data information is closely related to a musical beat composed of musical notes, so that the note rhythm, the note variation rate, and the like of the accompaniment note in the musical accompaniment are determined with the assistance of the beat data information.

In some embodiments, the beat data information is configured to determine a rhythm type corresponding to the musical accompaniment through the number of musical beats per unit time. Exemplarily, the rhythm type includes slow, moderate, and fast tempos, among others.

In some embodiments, as information determined by chord content composed of at least two musical notes, the chord data information is closely related to the musical note itself. Therefore, the note form of the accompaniment note in the musical accompaniment is determined with the assistance of the chord data information; that is, a note that should be used in the musical accompaniment is determined, thereby improving the accuracy of the musical accompaniment in more detail.

In some embodiments, the chord data information is configured to assist the melody data information in determining the degree of note coordination through a chord position.

In the embodiments of the present disclosure, the melody data information is configured to define the note variation range corresponding to the musical accompaniment, the beat data information is configured to determine the rhythm type corresponding to the musical accompaniment, and the chord data information is configured to determine the degree of note coordination. The musical accompaniment determined based on the three pieces of data fits well with the musical data, which is beneficial to ensuring the effect and efficiency of accompaniment generation.

In some embodiments, each musical measure is analyzed to acquire an accompaniment texture separately corresponding to each musical measure.

In some embodiments, the classification of accompaniment textures is common to the combination of different parts (e.g., harmony, bass, and percussion) in the musical piece, as well as their roles in the musical piece. The accompaniment texture includes: harmonic accompaniment (based on chords, responsible for supporting a main melody), rhythmic accompaniment (based on drumbeats and percussion, responsible for providing the sense of rhythm), bass accompaniment (based on bass instruments, providing a stable bass basis for music), melodic accompaniment (accompanied by a main melody, and supporting and highlighting a main melody through harmony, instrument, or music decoration), and the like.

That is, based on the melody, the chords, and the beats, the type of an accompaniment texture separately corresponding to each musical measure is comprehensively determined, so as to adjust the corresponding musical measure through the accompaniment texture.

In some embodiments, in the case that the texture conversion is performed in a unit of a measure, each song is processed in a sequential process from beginning to end. To adapt to songs of different tempos, three sets of texture conversion programs are designed based on the BPM. The BPM of not more than 90 is determined as a slow tempo, the BPM of more than 90 but less than 120 is determined as a moderate tempo, and the BPM of 120 is determined as a fast tempo. The texture of a slow-tempo song features the most diverse rhythm types; while in most cases, in a moderate-tempo song, the minimum note value is an eighth note, and in a fast-tempo song, it is typically a quarter note.

After the tempo is determined, the process proceeds to the determination of the melody of the measure. The pitch range, the note density, and the pitch of the lowest note of the melody are calculated, and a high or low, and sparse or dense accompaniment texture is selected. In each case, selecting an accompaniment texture from alternatives meeting the condition also exhibits certain randomness. For the first measure, it is necessary to determine whether the first measure is an anacrusis and whether to add a prelude. The determination rules are as follows. For a non-anacrusis measure or a measure where the first note begins before the second beat, the measure is processed as a standard measure. For an anacrusis where the first note occurs before the third beat, no accompaniment is provided. For an anacrusis where the first note occurs on or after the third beat, either no accompaniment or a prelude is randomly selected, and the accompaniment texture is selected for the prelude based on the first chord only.

After the accompaniment texture is selected, to avoid an error in the total value of notes in the measure, which would otherwise lead to deviation accumulation, a restriction on the number of beats per measure can be set. That is, under a limited number of loops, it is determined whether the sum of values of all notes in the current measure is equal to four beats; in the case that the sum is greater than four beats, the last note or rest is removed, and in the case that the sum is less than four beats, a rest is added. To avoid damage to the designed accompaniment texture, there is no such restriction on a measure that needs to be accompanied by a prelude and the ending measure.

For the last accompaniment measure, the melody can be determined first. An empty measure is directly accompanied by a coda; in the case that the rest reaches three beats and the last note ends on or before the first beat, or the note is sustained, one beat of a chord is added and then a coda is provided; for other cases, two beats of chords are added and then a coda is provided.

It should be noted that the above are only examples given in some embodiments, which are not limited in the embodiments of the present disclosure.

In step 420, adjusted measures respectively corresponding to the at least two musical measures are obtained by adjusting note values of musical notes in a musical measure corresponding to an accompaniment texture by the accompaniment texture.

In some embodiments, after acquiring the accompaniment texture separately corresponding to each musical measure, the musical notes in the musical measure can be adjusted by the accompaniment texture.

In some embodiments, note values corresponding to musical notes are adjusted by the accompaniment texture, and the note value is configured to represent the duration of the musical note.

In some embodiments, the value of the musical note is modified within the musical measure, so that the musical note becomes shorter or longer. The process is achieved by splitting a musical note into shorter notes or combining at least two musical notes into one longer note. For example, a quarter note is divided into two eighth notes, or two eighth notes are combined into one quarter note.

In addition, in the case that the value of the musical note is modified, the note value is also adjusted using legato or staccato. That is, adjacent musical notes are connected through legato, so that they are closer in time; a short interval is created between musical notes through staccato, which increases some sense of separation.

In some embodiments, ornaments are added to musical notes in the musical measure by the accompaniment texture, such as trill, glissando, and legato, which enable the original musical notes to be more expressive. These ornaments add variations to the music without changing the basic melody.

In some embodiments, a new rhythm pattern is also introduced in the musical measure by the accompaniment texture, for example: the introduction of more complex drumbeats, accents on weak beats, or cross rhythms. The process is achieved by varying the drumbeats or other percussion instruments within the accompaniment texture.

In some embodiments, the weak beat or other parts of the time signature are accented in the musical measure by the accompaniment texture, so as to enable the musical accompaniment to be more dynamic.

In some embodiments, acceleration or deceleration is performed at the end of the musical measure by the accompaniment texture, thereby creating a gradual variation or the like.

In some embodiments, the above content is determined based on the accompaniment texture corresponding to the musical measure, and the accompaniment texture is determined by integrating the texture determination rule, the melody, the chord, and the beat.

The adjusted measure includes at least two adjusted musical notes.

In some embodiments, musical notes in the corresponding musical measure are adjusted by the accompaniment texture to obtain at least two adjusted musical notes, so as to determine adjusted musical notes in each musical measure; each adjusted musical measure is referred to as an adjusted measure.

In step 430, the musical accompaniment data is generated by combining the adjusted measures respectively corresponding to the at least two musical measures.

In some embodiments, a temporal relationship of the at least two musical measures in the musical data is determined; at least two adjusted measures are combined according to the temporal relationship to generate the musical accompaniment data.

In some embodiments, the adjusted measure is obtained by adjusting the musical note by the accompaniment texture, and thus, the adjusted measure focuses on expressing the digital information of the musical accompaniment, and the musical accompaniment data generated by at least two adjusted measures also focuses on expressing the digital information of the musical accompaniment. For example, the musical accompaniment data is information expressed in the form of a MIDI file. Further, the accompaniment texture is determined through the texture determination rule, the melody data information, the beat data information, and the chord data information, which is beneficial to ensuring the accuracy and efficiency of determining the accompaniment texture, thereby improving the generation effect of the musical accompaniment.

It should be noted that the above are only examples given in some embodiments, which are not limited in the embodiments of the present disclosure.

In summary, the beat data information, the chord data information, and the melody data information are extracted from the acquired musical data; the musical accompaniment data is generated through the beat data information and the chord data information with the melody data information as the generation restriction condition, and finally, the musical accompaniment is obtained by rendering the musical accompaniment data. In the process of generating the musical accompaniment data through the musical data, the musical beats and the musical notes are quantized through a musical information extraction process, improving the analysis precision of the musical data, so that the process of generating the accompaniment data is more targeted. In addition, beats and chords are incorporated into the process of generating the accompaniment melody under the definition of the musical melody by integrating the melody data information, the beat data information, and the chord data information, so that the musical accompaniment data can be presented in more detail through music parameters, and then the musical accompaniment of the musical data obtained by rendering the musical accompaniment data is more precise, thereby improving the generation stability and the generation effect of the musical accompaniment.

In some embodiments, in the case that the audio data rendering is performed through the musical accompaniment data, to improve the melody accuracy of the musical accompaniment data, the melody data information and the musical accompaniment data are subjected to mixing processing, and then a musical result is obtained by performing audio data rendering on a mixing result. In some embodiments, as shown in FIG. 5, the embodiments shown in FIG. 2 are also implemented as the following steps 510 to 550; step 240 shown in FIG. 2 is also implemented as the following steps 540 to 550.

In step 510, musical data is acquired.

The musical data is divided into at least two musical beats, each musical beat including musical notes.

In some embodiments, step 510 is described in the above step 210, which will not be repeated herein.

In step 520, beat data information, chord data information, and melody data information are extracted from the musical data.

The beat data information is configured to represent the variation speed of the at least two musical beats, the chord data information is configured to describe a chord unit extracted in a unit of the musical beat, and the melody data information is configured to describe the note variation between at least two musical notes.

In some embodiments, step 520 is described in the above steps 220, and 310 to 330, which will not be repeated herein.

In step 530, musical accompaniment data is generated based on the melody data information, the beat data information, and the chord data information.

The melody data information is configured to define an accompaniment melody of the musical accompaniment with a musical melody of the musical data, and the musical accompaniment data describes the accompaniment of the musical data by music parameters.

In some embodiments, step 530 is described in the above steps 230, and 410 to 430, which will not be repeated herein.

In step 540, a mixing result is obtained by performing mixing processing on the melody data information and the musical accompaniment data.

In some embodiments, to present the musical melody more accurately while reflecting the accompaniment, the melody data information corresponding to the musical melody is mixed with the generated musical accompaniment data.

Mixing refers to the process of combining different audio tracks (such as melody and accompaniment) together to create an overall music. The purpose of mixing is to combine individual audio tracks into a complete music composition while maintaining audio clarity and balance. The purpose of performing mixing processing on the melody data information and the musical accompaniment data is to create the sense of unity of the music, so that the musical melody data corresponding to the musical data itself and the generated musical accompaniment data become an organic unity. As a result, after mixing, the musical melody data and the musical accompaniment data can support and highlight each other without suppressing each other, thereby forming audio effects such as equalization, compression, and reverb.

In some embodiments, the mixing result is generated by performing mixing processing on the melody data information and the musical accompaniment data by a reverb for sound sources.

In some embodiments, both the melody data information and the musical accompaniment data are implemented as MIDI files, and the melody data information and the musical accompaniment data involved in the mixing processing are combined together to create an integral MIDI file. This can be adjusted in terms of notes, volume, instrument, and the like to create a more complex and rich music composition.

In some embodiments, a musical melody track corresponding to the melody data information and a musical accompaniment track corresponding to the musical accompaniment data are determined; the mixing result is generated by performing mixing processing on the musical melody track and the musical accompaniment track under the condition that audio tracks are aligned.

In some embodiments, the melody data information represents the musical melody track, including the performance of musical notes based on the melody data information; the musical accompaniment data represents the musical accompaniment track, including the performance of musical notes based on the musical accompaniment data. Mixing processing is performed on the musical melody track and the musical accompaniment track under the condition that audio tracks are aligned, that is, the musical melody track and the musical accompaniment track are aligned, thereby generating the mixing result. In this way, the correctness of mixing processing can be ensured, thereby improving the accuracy of the generated mixing result.

In some embodiments, the mixing processing is implemented as follows.
(1) Import of melody data information and musical accompaniment data: Two pieces of information to be mixed are imported into MIDI editing software or a digital audio workstation (DAW) to ensure that they are correctly aligned on the time axis.
(2) Start point adjustment: It is ensured that the melody data information and the musical accompaniment data start from the same start point on the time axis, so that they can be synchronized.
(3) Note editing: Musical notes in the melody data information and the musical accompaniment data are edited. For example, some notes are deleted or adjusted to better blend them with each other. It may also be considered to adjust the values of some notes to create richer chord or melody variations.
(4) Volume balance: The volume of the melody data information and the volume of the musical accompaniment data are adjusted to ensure that they are balanced after mixing, which may be achieved by adjusting volume controllers on channels respectively corresponding to the melody data information and the musical accompaniment data.
(5) Instrument and expression: In the mixing process, the instrument (musical instrument selection) and expressive controllers (such as volume, note length, and instrument) on channels respectively corresponding to the melody data information and the musical accompaniment data can be adjusted to enable the overall music to be more expressive.
(6) Rhythm and sense of time: The rhythm and the sense of time of the melody data information and the musical accompaniment data are adjusted, so that they are better coordinated after mixing, such as the time offset of musical notes and the addition of some artificial micro-value variations.
(7) Effect processing: Some transformation effects are applied, such as a merging effect, a delay effect, or a chorus effect, to increase the complexity and the sense of depth of mixing.
(8 ) Mixing and exporting: In the final stage of the mixing process, after ensuring that the mixing effect of the melody data information and the musical accompaniment data reaches a preset requirement, a mixing result after mixing is exported, and the mixing result is implemented in the form of a MIDI file.

In step 550, a musical result corresponding to the musical data is obtained by performing audio data rendering on the mixing result.

The musical result uses the musical accompaniment as accompaniment content.

In some embodiments, after obtaining the mixing result, audio data rendering is performed on the mixing result to obtain the musical result expressing the complete musical content. Since the generation of the musical result relies on the musical accompaniment data, the musical result includes the musical accompaniment corresponding to the musical accompaniment data, which is beneficial to more truly presenting the musical content through the melody data information while generating the musical accompaniment.

In some embodiments, the mixing data is implemented in the form of a digital representation, i.e., a MIDI file, which describes the musical data. In the case that the musical result corresponding to the mixing data needs to be acquired, the MIDI file includes music information such as notes, pitches, and values, but does not include sound waveforms, and thus, the MIDI file needs to be converted into data for rendering the obtained musical result. That is, audio conversion is performed based on the mixing result first to obtain a musical result audio, and audio rendering is performed on the musical result audio to obtain the musical result.

In some embodiments, the musical result audio obtained after the audio conversion is rendered to obtain the musical result. For example, the musical result audio is turned on by the terminal device, thereby playing the musical result with the musical accompaniment.

It should be noted that the above are only examples given in some embodiments, which are not limited in the embodiments of the present disclosure.

In summary, the beat data information, the chord data information, and the melody data information are extracted from the acquired musical data; the musical accompaniment data is generated through the beat data information and the chord data information with the melody data information as the generation restriction condition, and finally, the musical accompaniment is obtained by rendering the musical accompaniment data. In the process of generating the musical accompaniment data through the musical data, the musical beats and the musical notes are quantized through a musical information extraction process, improving the analysis precision of the musical data, so that the process of generating the accompaniment data is more targeted. In addition, beats and chords are incorporated into the process of generating the accompaniment melody under the definition of the musical melody by integrating the melody data information, the beat data information, and the chord data information, so that the musical accompaniment data can be presented in more detail through music parameters, and then the musical accompaniment of the musical data obtained by rendering the musical accompaniment data is more precise, thereby improving the generation stability and the generation effect of the musical accompaniment.

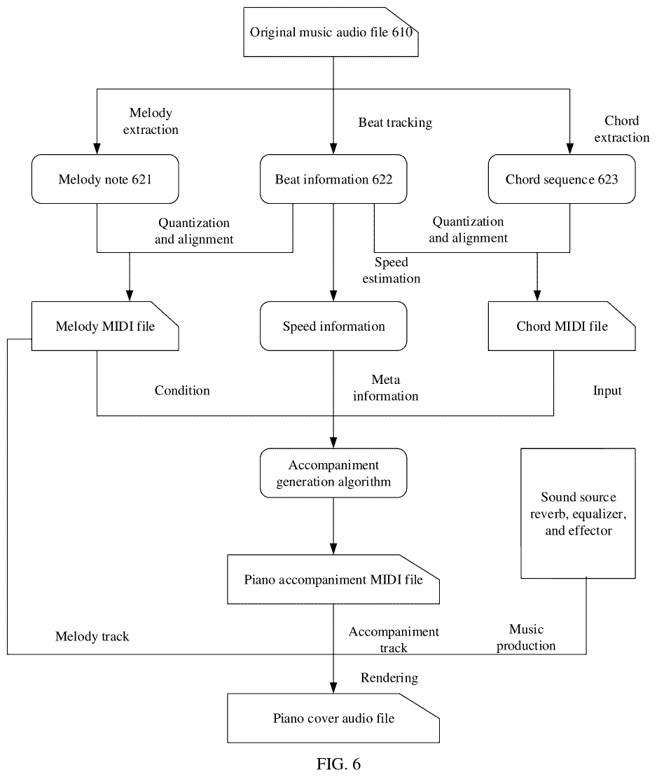

In some embodiments, the above musical data is implemented as any popular song. In the case that the method for generating the musical accompaniment is applied to the accompaniment generation process of popular music, the method is also referred to as “a method for automatically generating a symbol domain piano cover of a popular song”. FIG. 6 shows an overall framework diagram of the embodiments of the present disclosure.

In some embodiments, after acquiring an original music audio file 610 (i.e., the above musical data), a preset algorithm (such as neural network transform) is first used to perform melody extraction, beat tracking, and chord extraction on the original music audio file 610 to acquire music information, including melody notes 621 after melody extraction, beat information 622 after beat tracking, and a chord sequence 623 after chord extraction.

The extracted melody notes 621 are represented by a starting point, an offset point, and pitch; the melody notes 621 are aligned with the beat information 622 detected from the original music audio file 610 and quantized to sixteenth notes to obtain a melody MIDI file (i.e., the above melody data information).

In chord extraction, one beat serves as the minimum unit, including a major triad and a minor triad, to obtain the chord sequence 623.

After the measure without melody is deleted from the melody and the chord sequence, the MIDI file is synthesized, and the time signature is 4/4 time.

In addition, the speed information, i.e., the BPM, of the original music audio file 610 is further estimated from the beat information 622, and a slight deceleration is performed on the average speed of the original music audio file 610; next, while controlling the range, degree of density, and the like of the accompaniment under the condition of the melody, the accompaniment generation algorithm generates a texture matching the melody based on the degree, type, and the like of the chord, and outputs a piano accompaniment MIDI file (i.e., musical accompaniment data). Finally, the MIDIs of the melody track and the accompaniment track are rendered into the audio file (i.e., the musical audio for rendering the obtained musical accompaniment) of a piano cover through a batch music production method.

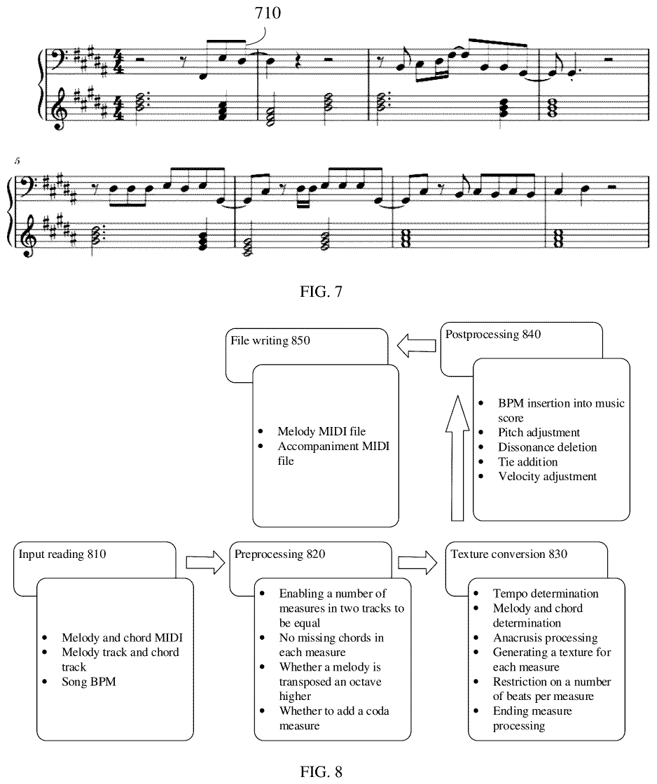

In some embodiments, an input example of the accompaniment generation algorithm is shown in FIG. 7, where at least two notes 710 are included, and the input file is in a “.mid” format, i.e., a MIDI file, which stores both the melody track and the chord track, and includes time signatures (both 4/4 time) and key signature meta information. The chord preprocessing is in the form of a specific pitch instead of chord marks such as “C” and “Am”. The pitch range of the input chord is within the default register (starting from the one-lined octave), and only root-position major and minor triads are considered. However, the texture contains inversions, seventh chords, and ninth chords.

The method for generating accompaniment is performed using the accompaniment generation algorithm. As shown in FIG. 8, the method mainly includes the following five processes: (1) input reading 810: input MIDI and BPM reading; (2) preprocessing 820: chord track preprocessing; (3) texture conversion 830; (4) postprocessing 840: melody and accompaniment postprocessing; and (5) (MIDI) file writing 850.

### (1) Input reading 810

In some embodiments, the input MIDI file is read, the melody and the chord are stored in two parts in two tracks, and the estimated BPM of the original music is input as one of the conditions for selecting the accompaniment texture.

### (2) Preprocessing 820

The number of measures in the melody track and the number of measures in the chord track are calculated, respectively. In the case that the number of measures in the chord track is less than the number of measures in the melody track, the measure is filled, and the chord of the previous measure is copied as the chord of the filled measure. In addition, each measure is detected. To avoid an excessive rest in the accompaniment, in the case that there is a measure without any chord, the chord of the previous measure is copied by the algorithm; and in the case that the measure is the first measure, the chord of the first subsequent measure that is not a whole rest is copied.

For some songs with generally low-pitched melodies, the melody can be transposed an octave higher to improve the listening experience while preventing conflict with the accompaniment. The specific determination method is to use MIDI pitches 56 and 70 as thresholds, and separately calculate a bass note ratio and a treble note ratio. In the case that the treble note ratio exceeds 10% and the bass note ratio is lower than 20%, high octave processing is not performed.

To enable the completeness and the sense of cadence of the music, a coda may be added to each musical piece, with the length ranging from one measure to three measures. Different musical melodies end with different measures, some ending with a sustained note, others featuring a long rest, while some lack sufficient time for an added coda. Therefore, it is necessary to determine in advance whether to add a coda measure to the accompaniment track. The specific determination rule is as follows. In the case that the last note of the ending measure of the melody ends after the second beat and is not a sustained note, an empty coda measure is added in advance, and the chord is copied from the chord of the previous measure. During the texture conversion of the coda, in the case that the selected texture exceeds four beats, it will be extended to two or three measures in the case that the MIDI is written.

### (3) Texture Conversion 830

In the case that the texture conversion is performed in a unit of a measure, each song is processed in a sequential process from beginning to end. To adapt to songs of different tempos, three sets of texture conversion programs are designed based on the BPM. The BPM of not more than 90 is determined as a slow tempo, the BPM of more than 90 but less than 120 is determined as a moderate tempo, and the BPM of 120 is determined as a fast tempo. The texture of a slow-tempo song features the most diverse rhythm types; while in most cases, in a moderate-tempo song, the minimum note value is an eighth note, and in a fast-tempo song, it is typically a quarter note.

After the tempo is determined, the process proceeds to the determination of the melody of the measure. The pitch range, the note density, and the pitch of the lowest note of the melody are calculated, and a high or low, and sparse or dense texture is selected. In each case, selecting a texture from alternatives meeting the condition also exhibits certain randomness. For the first measure, it is necessary to determine whether the first measure is an anacrusis and whether to add a prelude. The specific rules are as follows. For a non-anacrusis measure or a measure where the first note begins before the second beat, the measure is processed as a standard measure. For an anacrusis where the first note occurs before the third beat, no accompaniment is provided. For an anacrusis where the first note occurs on or after the third beat, either no accompaniment or a prelude is randomly selected, and the texture is selected for the prelude based on the first chord only.

After the texture is selected, to avoid an error in the total value of notes in the measure, which would otherwise lead to deviation accumulation, a restriction on the number of beats per measure is set. That is, under a limited number of loops, it is determined whether the sum of values of all notes in the current measure is equal to four beats; in the case that the sum is greater than four beats, the last note or rest is removed; and in the case that the sum is less than four beats, a rest is added. To avoid damage to the designed texture, there is no such restriction on a measure that needs to be accompanied by a prelude and the ending measure.

For the last accompaniment measure, the melody is determined by the algorithm first. An empty measure is directly accompanied by a coda; in the case that the rest reaches three beats and the last note ends on or before the first beat, or the note is sustained, one beat of a chord is added and then a coda is provided; for other cases, two beats of chords are added and then a coda is provided.

In some embodiments, texture types include a block-chord texture, a partially arpeggiated texture, and a fully arpeggiated texture. The rhythm patterns include a quarter-note rhythm, a two-eighth-note rhythm, a sixteenth-note rhythm, a syncopation, a dotted rhythm, a quintuplet rhythm, and the like, and include ornaments such as arpeggio, featuring a rich diversity. In the case that only major and minor triads are input, seventh chords, ninth chords, thirteenth chords, and chord inversions are selectively added based on the range and the degree of density of the melody to extend the chord type. In the case of considering the tempo of songs, various specially designed textures can cover various styles of songs, such as lyric slow-tempo songs, moderate-tempo songs, and fast-tempo hot songs, while maintaining a soothing overall style. In addition, the texture of the prelude is designed for the anacrusis whose rest reaches three beats; the anacrusis is not accompanied by the accompaniment. The two cases can be randomly selected. To enable the sense of cadence of the musical piece, a variety of codas are also designed, and the coda is selected based on information such as the value and ending position of notes of the ending measure of the melody.

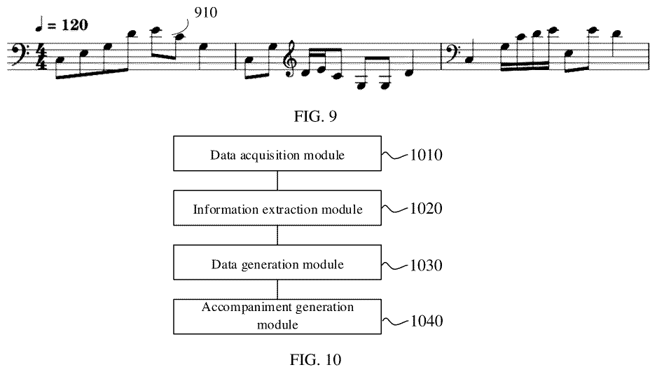

Texture conversion is divided into two conversion modes: function conversion and file conversion. Function conversion is simple and stable and can be applied to all input chord types, while file conversion is more conducive to extension. The function conversion refers to the process that, for various chord values within a measure, the relevant texture conversion function directly extracts fundamental notes from the chords, designs pitch and values based on harmonics, combines single notes and chords, generates a complete texture measure, and returns the texture measure. The file conversion refers to the use of a digital music score file, i.e., an “.mxl” file, to store the texture of each measure. Based on two cases of a major triad and a minor triad, as well as four cases of chord values of four beats, three beats, two beats, and one beat, each type of texture is divided into eight files. Each measure in the music score file stores a type of texture, consisting of C or Cm chords and their variants. During use, the texture is transposed according to the interval relationship between the root note of the current chord and the pitch of C4. FIG. 9 shows an example of a texture file in which at least two musical notes 910 are shown, and the at least two musical notes 910 represent a Cadd9 chord with a value of four beats.

### (4) Postprocessing 840

After the texture is converted, the algorithm first inserts the estimated BPM of the original music into the current music score and then adjusts the pitch of the accompaniment except for the first and last measures to obtain a better listening experience. Single notes below G2 are transposed an octave higher, and notes in the chord below A2 are also transposed an octave higher. Accompaniment notes that are higher than the melody will be transposed an octave lower. Secondly, notes in the melody and accompaniment that have close starting points are compared, and dissonant major and minor seconds and identical notes are adjusted. In addition, for repeated identical notes in the accompaniment, a tie is added (excluding chords). Finally, the velocities of the melody and accompaniment are adjusted for post-audio production.

### (5) MIDI file writing 850

After all the above steps are completed, the melody and the accompaniment are stored as two MIDI files, respectively, to facilitate subsequent audio rendering in batches.

It should be noted that the above are only examples given in some embodiments, which are not limited in the embodiments of the present disclosure.

In summary, in the process of generating the musical accompaniment data through the musical data, the musical beats and the musical notes are quantized through a musical information extraction process, improving the analysis precision of the musical data, so that the process of generating the accompaniment data is more targeted. Further, beats and chords are incorporated into the process of generating the accompaniment melody under the definition of the musical melody by integrating the melody data information, the beat data information, and the chord data information, so that the musical accompaniment data can be presented in more detail through music parameters, and then the musical accompaniment that can present the musical data more precisely is obtained by rendering the musical accompaniment data, thereby improving the generation stability and the generation effect of the musical accompaniment.

FIG. 10 is a structural block diagram of an apparatus for generating musical accompaniment according to some exemplary embodiments of the present disclosure. As shown in FIG. 10, the apparatus includes:
a data acquisition module 1010, configured to acquire musical data, wherein the musical data is divided into at least two musical beats, each of the musical beats including musical notes;
an information extraction module 1020, configured to extract beat data information, chord data information, and melody data information from the musical data, wherein the beat data information is configured to describe a variation speed of the at least two musical beats, the chord data information is configured to describe a chord unit extracted in a unit of the musical beat, and the melody data information is configured to describe a note variation between at least two musical notes;
a data generation module 1030, configured to generate musical accompaniment data based on the melody data information, the beat data information, and the chord data information, wherein the melody data information is configured to define an accompaniment melody of the musical accompaniment with a musical melody of the musical data, and the musical accompaniment data is configured to describe accompaniment of the musical data; and
an accompaniment generation module 1040, configured to obtain musical accompaniment corresponding to the musical data by performing audio data rendering based on the musical accompaniment data.

In some embodiments, the information extraction module 1020 is further configured to determine the beat data information based on the number of the at least two musical beats per unit time; extract a chord track and a melody track corresponding to the musical data, wherein the chord track is configured to describe a tone cluster constructed by the at least two musical notes in the form of a chord, and the melody track is configured to describe a melody formed by the at least two musical notes according to a temporal relationship; and determine the melody data information and the chord data information separately corresponding to the musical data based on the melody track and the chord track.

In some embodiments, the information extraction module 1020 is further configured to obtain the chord data information by adjusting the number of measures in the chord track by taking the number of measures in the melody track as a reference; and obtain the melody data information by performing melody transformation on the melody track based on note pitches respectively corresponding to the at least two musical notes in the melody track.

In some embodiments, the information extraction module 1020 is further configured to acquire a preset first pitch and a preset second pitch, wherein the first pitch and the second pitch are configured to define a transformation method for performing the melody transformation on the melody track; determine a first note ratio and a second note ratio by comparing the note pitches respectively corresponding to the at least two musical notes in the melody track with the first pitch and the second pitch, respectively, wherein the first note ratio is configured to represent the note ratio of a first note to the at least two musical notes, the first note being configured to represent a musical note lower than the first pitch, and the second note ratio is configured to represent the note ratio of a second note to the at least two musical notes, the second note being configured to represent a musical note higher than the second pitch; and obtain the melody data information by performing the melody transformation on the melody track based on the first note ratio and the second note ratio.

In some embodiments, the data generation module 1030 is further configured to determine accompaniment textures respectively corresponding to at least two musical measures based on the beat data information and the chord data information with the melody data information as a generation restriction condition for the musical accompaniment in a unit of a musical measure, wherein one musical measure includes a preset number of musical beats, and each of the accompaniment textures is a sound element configured to support and highlight a melody corresponding to the melody data information; obtain adjusted measures respectively corresponding to the at least two musical measures by adjusting note values of musical notes in a musical measure corresponding to an accompaniment texture by the accompaniment texture, wherein each of the note values is configured to represent the duration of the musical note, and each of the adjusted measures includes at least two adjusted musical notes; and generate the musical accompaniment data by combining the adjusted measures respectively corresponding to the at least two musical measures.

In some embodiments, the data generation module 1030 is further configured to acquire a texture determination rule, wherein the texture determination rule is configured to determine an accompaniment texture corresponding to a musical measure through a musical information extraction result, the musical information extraction result including at least one of the beat data information, the chord data information, or the melody data information; and determine the accompaniment textures respectively corresponding to the at least two musical measures by defining the note variation range of the musical accompaniment through the melody data information, defining the rhythm variation of the musical accompaniment through the beat data information, and defining the degree of note coordination of the musical accompaniment through the chord data information under the definition of the texture determination rule.

In some embodiments, the melody data information is configured to define a note variation range corresponding to the musical accompaniment through a pitch range, a pitch density, and a pitch value;
the beat data information is configured to determine a rhythm type corresponding to the musical accompaniment through the number of musical beats per unit time; and
the chord data information is configured to assist the melody data information in determining the degree of note coordination through a chord position.

In some embodiments, the accompaniment generation module 1040 is further configured to obtain a mixing result by performing mixing processing on the melody data information and the musical accompaniment data; and obtain a musical result corresponding to the musical data by performing audio data rendering on the mixing result, wherein the musical result uses the musical accompaniment as accompaniment content.

In some embodiments, the accompaniment generation module 1040 is further configured to determine a musical melody track corresponding to the melody data information and a musical accompaniment track corresponding to the musical accompaniment data; and generate the mixing result by performing mixing processing on the musical melody track and the musical accompaniment track under a condition that audio tracks are aligned.

In summary, the beat data information, the chord data information, and the melody data information are extracted from the acquired musical data; the musical accompaniment data is generated through the beat data information and the chord data information with the melody data information as the generation restriction condition, and finally, the musical accompaniment is obtained by rendering the musical accompaniment data. In the process of generating the musical accompaniment data through the musical data, the musical beats and the musical notes are quantized through a musical information extraction process, improving the analysis precision of the musical data, so that the process of generating the accompaniment data is more targeted. In addition, beats and chords are incorporated into the process of generating the accompaniment melody under the definition of the musical melody by integrating the melody data information, the beat data information, and the chord data information, so that the musical accompaniment data can be presented in more detail through music parameters, and then the musical accompaniment of the musical data obtained by rendering the musical accompaniment data is more precise, thereby improving the generation stability and the generation effect of the musical accompaniment.

It should be noted that for the apparatus for generating the musical accompaniment according to the above embodiments, the division of the functional modules is merely exemplary. In practice, the functions described above can be assigned to different functional modules as needed, that is, the internal structure of the device can be divided into different functional modules, so as to implement all or part of the above functions. In addition, the apparatus for generating the musical accompaniment and the method for generating the musical accompaniment according to the above embodiments belong to the same concept, and specific implementation processes thereof are described in the method embodiments in detail, and are not repeated herein.

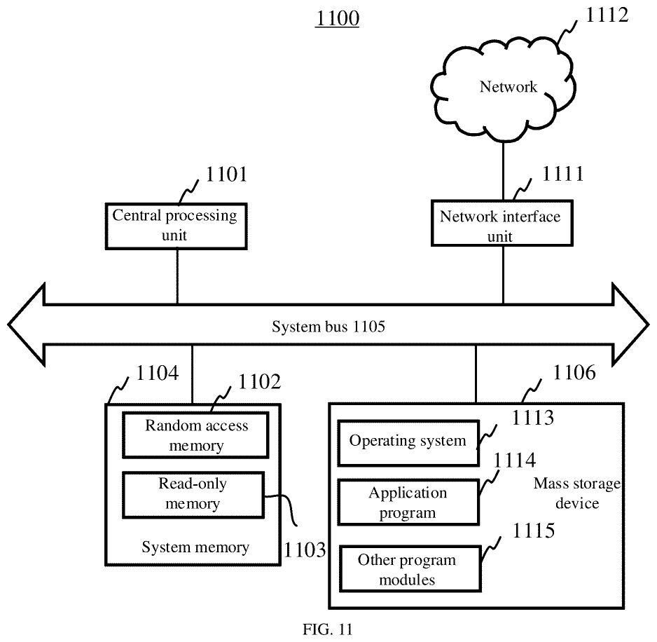

FIG. 11 shows a schematic structural diagram of a computer device according to some exemplary embodiments of the present disclosure. The computer device 1100 includes a central processing unit (CPU) 1101, a system memory 1104 including a random-access memory (RAM) 1102 and a read-only memory (ROM) 1103, and a system bus 1105 for connecting the system memory 1104 to the CPU 1101. The computer device 1100 further includes a mass storage device 1106 for storing an operating system 1113, an application program 1114, and other program modules 1115.

The mass storage device 1106 is connected to the CPU 1101 through a mass storage controller (not shown) connected to the system bus 1105. The mass storage device 1106 and computer-readable media associated therewith provide non-volatile storage for the computer device 1100. That is, the mass storage device 1106 may include a computer-readable medium (not shown) such as a hard disk or a compact disc read-only memory (CD-ROM) drive.

Generally, the computer-readable medium includes a computer storage medium and a communication medium. The computer storage media includes a volatile and non-volatile, removable and non-removable medium achieved in any method or technology for storage of information such as computer-readable instructions, data structures, program modules, or other data. The system memory 1104 and the mass storage device 1106 described above are collectively referred to as the memory.

According to various embodiments of the present disclosure, the computer device 1100 is further connected to a remote computer on a network over the network, such as the Internet, for running. That is, the computer device 1100 is connected to the network 1112 by a network interface unit 1111 connected to the system bus 1105, or is connected to other types of networks or remote computer systems (not shown) using the network interface unit 1111.

The above memory further includes one or more programs, which are stored in the memory and are configured to be executed by the CPU.

The embodiments of the present disclosure further provide a computer device. The computer device includes a processor and a memory storing at least one program, wherein the at least one program, when loaded and executed by the processor, causes the processor to perform the method for generating the musical accompaniment according to the above method embodiments.

The embodiments of the present disclosure further provide a computer-readable storage medium. The computer-readable storage medium stores at least one program, wherein the at least one program, when loaded and executed by a processor, causes the processor to perform the method for generating the musical accompaniment according to the above method embodiments.

The embodiments of the present disclosure further provide a computer program product. The computer program product includes one or more computer programs stored in a computer-readable storage medium. The one or more computer programs, when read from the computer-readable storage medium by a processor of a computer device and executed by the processor, cause the computer device to perform the method for generating the musical accompaniment as defined in any one of the above embodiments of the present disclosure.

Described above are merely optional embodiments of the present disclosure and are not intended to limit the present disclosure. Any modifications, equivalent substitutions, improvements, and the like, made within the spirit and principle of the present disclosure shall fall within the protection scope of the present disclosure.

1. A method for generating musical accompaniment, performed by a computer device, comprising:
acquiring musical data, wherein the musical data is divided into at least two musical beats, each of the musical beats comprising musical notes;
extracting beat data information, chord data information, and melody data information from the musical data, wherein the beat data information is configured to describe a variation speed of the at least two musical beats, the chord data information is configured to describe a chord unit extracted in a unit of the musical beat, and the melody data information is configured to describe a note variation between at least two musical notes;
generating musical accompaniment data based on the melody data information, the beat data information, and the chord data information, wherein the melody data information is configured to define an accompaniment melody of musical accompaniment with a musical melody of the musical data, and the musical accompaniment data is configured to describe accompaniment of the musical data; and
obtaining musical accompaniment corresponding to the musical data by performing audio data rendering based on the musical accompaniment data.

2. The method according to claim 1, wherein said extracting the beat data information, the chord data information, and the melody data information from the musical data comprises:
determining the beat data information based on a number of the at least two musical beats per unit time;
extracting a chord track and a melody track corresponding to the musical data, wherein the chord track is configured to describe a tone cluster constructed by the at least two musical notes in a form of a chord, and the melody track is configured to describe a melody formed by the at least two musical notes according to a temporal relationship; and
determining the melody data information and the chord data information based on the melody track and the chord track.

3. The method according to claim 2, wherein said determining the melody data information and the chord data information based on the melody track and the chord track comprises:
obtaining the chord data information by adjusting a number of measures in the chord track by taking a number of measures in the melody track as a reference; and
obtaining the melody data information by performing melody transformation on the melody track based on note pitches respectively corresponding to the at least two musical notes in the melody track.

4. The method according to claim 3, wherein said obtaining the melody data information by performing the melody transformation on the melody track based on the note pitches respectively corresponding to the at least two musical notes in the melody track comprises:
acquiring a preset first pitch and a preset second pitch, wherein the preset first pitch and the preset second pitch are configured to define a transformation method for performing the melody transformation on the melody track;
determining a first note ratio and a second note ratio by comparing the note pitches respectively corresponding to the at least two musical notes in the melody track with the preset first pitch and the preset second pitch, respectively, wherein the first note ratio is configured to represent a note ratio of a first note to the at least two musical notes, the first note being configured to represent a musical note lower than the preset first pitch, and the second note ratio is configured to represent a note ratio of a second note to the at least two musical notes, the second note being configured to represent a musical note higher than the preset second pitch; and
obtaining the melody data information by performing the melody transformation on the melody track based on the first note ratio and the second note ratio.

5. The method according to claim 1, wherein said generating the musical accompaniment data based on the melody data information, the beat data information, and the chord data information comprises:
determining accompaniment textures respectively corresponding to at least two musical measures based on the beat data information and the chord data information with the melody data information as a generation restriction condition for the musical accompaniment in a unit of a musical measure, wherein one musical measure comprises a preset number of musical beats, and each of the accompaniment textures is a sound element configured to support and highlight a melody corresponding to the melody data information;
obtaining adjusted measures respectively corresponding to the at least two musical measures by adjusting note values of musical notes in a musical measure corresponding to an accompaniment texture by the accompaniment texture, wherein each of the note values is configured to represent duration of a musical note, and each of the adjusted measures comprises at least two adjusted musical notes; and
generating the musical accompaniment data by combining the adjusted measures respectively corresponding to the at least two musical measures.

6. The method according to claim 5, wherein said determining the accompaniment textures respectively corresponding to the at least two musical measures based on the beat data information and the chord data information with the melody data information as the generation restriction condition for the musical accompaniment comprises:
acquiring a texture determination rule, wherein the texture determination rule is configured to determine an accompaniment texture corresponding to a musical measure through a musical information extraction result, the musical information extraction result comprising at least one of the beat data information, the chord data information, or the melody data information; and
determining the accompaniment textures respectively corresponding to the at least two musical measures by defining a note variation range of the musical accompaniment through the melody data information, defining a rhythm variation of the musical accompaniment through the beat data information, and defining a degree of note coordination of the musical accompaniment through the chord data information under definition of the texture determination rule.

7. The method according to claim 1, wherein:
the melody data information is configured to define a note variation range corresponding to the musical accompaniment through a pitch range, a pitch density, and a pitch value;
the beat data information is configured to determine a rhythm type corresponding to the musical accompaniment through a number of musical beats per unit time; and
the chord data information is configured to assist the melody data information in determining a degree of note coordination through a chord position.

8. The method according to claim 1, further comprising:
obtaining a mixing result by performing mixing processing on the melody data information and the musical accompaniment data; and
obtaining a musical result corresponding to the musical data by performing audio data rendering on the mixing result, wherein the musical result uses the musical accompaniment as accompaniment content.

9. The method according to claim 8, wherein said obtaining the mixing result by performing the mixing processing on the melody data information and the musical accompaniment data comprises:
determining a musical melody track corresponding to the melody data information and a musical accompaniment track corresponding to the musical accompaniment data; and
generating the mixing result by performing mixing processing on the musical melody track and the musical accompaniment track under a condition that audio tracks are aligned.

10. An apparatus for generating a musical accompaniment, comprising:
a processor; and
a memory configured to store one or more instructions executable by the processor;
wherein the processor, when loading and executing the one or more instructions, is caused to perform the following method:
acquiring musical data, wherein the musical data is divided into at least two musical beats, each of the musical beats comprising musical notes;
extracting beat data information, chord data information, and melody data information from the musical data, wherein the beat data information is configured to describe a variation speed of the at least two musical beats, the chord data information is configured to describe a chord unit extracted in a unit of the musical beat, and the melody data information is configured to describe a note variation between at least two musical notes;
generating musical accompaniment data based on the melody data information, the beat data information, and the chord data information, wherein the melody data information is configured to define an accompaniment melody of the musical accompaniment with a musical melody of the musical data, and the musical accompaniment data is configured to describe accompaniment of the musical data; and
obtaining musical accompaniment corresponding to the musical data by performing audio data rendering based on the musical accompaniment data.

11. A computer device, comprising a processor and a memory storing at least one program, wherein the at least one program, when loaded and executed by the processor, causes the processor to perform:
acquiring musical data, wherein the musical data is divided into at least two musical beats, each of the musical beats comprising musical notes;
extracting beat data information, chord data information, and melody data information from the musical data, wherein the beat data information is configured to describe a variation speed of the at least two musical beats, the chord data information is configured to describe a chord unit extracted in a unit of the musical beat, and the melody data information is configured to describe a note variation between at least two musical notes;
generating musical accompaniment data based on the melody data information, the beat data information, and the chord data information, wherein the melody data information is configured to define an accompaniment melody of musical accompaniment with a musical melody of the musical data, and the musical accompaniment data is configured to describe accompaniment of the musical data; and
obtaining musical accompaniment corresponding to the musical data by performing audio data rendering based on the musical accompaniment data.

12. A non-transitory computer-readable storage medium storing at least one program, wherein the at least one program, when loaded and executed by a processor, causes the processor to perform the method for generating the musical accompaniment as defined claim 1.

13. A computer program product, comprising one or more computer programs, wherein the one or more computer programs, when executed by a processor, cause the processor to perform the method for generating the musical accompaniment as defined in claim 1.

14. The apparatus according to claim 10, wherein the processor, when loading and executing the one or more instructions, is caused to perform:
determining the beat data information based on a number of the at least two musical beats per unit time;
extracting a chord track and a melody track corresponding to the musical data, wherein the chord track is configured to describe a tone cluster constructed by the at least two musical notes in a form of a chord, and the melody track is configured to describe a melody formed by the at least two musical notes according to a temporal relationship; and
determining the melody data information and the chord data information based on the melody track and the chord track.

15. The apparatus according to claim 14, wherein the processor, when loading and executing the one or more instructions, is caused to perform:
obtaining the chord data information by adjusting a number of measures in the chord track by taking a number of measures in the melody track as a reference; and
obtaining the melody data information by performing melody transformation on the melody track based on note pitches respectively corresponding to the at least two musical notes in the melody track.

16. The apparatus according to claim 15, wherein the processor, when loading and executing the one or more instructions, is caused to perform:
acquiring a preset first pitch and a preset second pitch, wherein the preset first pitch and the preset second pitch are configured to define a transformation method for performing the melody transformation on the melody track;
determining a first note ratio and a second note ratio by comparing the note pitches respectively corresponding to the at least two musical notes in the melody track with the preset first pitch and the preset second pitch, respectively, wherein the first note ratio is configured to represent a note ratio of a first note to the at least two musical notes, the first note being configured to represent a musical note lower than the preset first pitch, and the second note ratio is configured to represent a note ratio of a second note to the at least two musical notes, the second note being configured to represent a musical note higher than the preset second pitch; and
obtaining the melody data information by performing the melody transformation on the melody track based on the first note ratio and the second note ratio.

17. The apparatus according to claim 10, wherein the processor, when loading and executing the one or more instructions, is caused to perform:
determining accompaniment textures respectively corresponding to at least two musical measures based on the beat data information and the chord data information with the melody data information as a generation restriction condition for the musical accompaniment in a unit of a musical measure, wherein one musical measure comprises a preset number of musical beats, and each of the accompaniment textures is a sound element configured to support and highlight a melody corresponding to the melody data information;
obtaining adjusted measures respectively corresponding to the at least two musical measures by adjusting note values of musical notes in a musical measure corresponding to an accompaniment texture by the accompaniment texture, wherein each of the note values is configured to represent duration of a musical note, and each of the adjusted measures comprises at least two adjusted musical notes; and
generating the musical accompaniment data by combining the adjusted measures respectively corresponding to the at least two musical measures.

18. The apparatus according to claim 17, wherein the processor, when loading and executing the one or more instructions, is caused to perform:
acquiring a texture determination rule, wherein the texture determination rule is configured to determine an accompaniment texture corresponding to a musical measure through a musical information extraction result, the musical information extraction result comprising at least one of the beat data information, the chord data information, or the melody data information; and
determining the accompaniment textures respectively corresponding to the at least two musical measures by defining a note variation range of the musical accompaniment through the melody data information, defining a rhythm variation of the musical accompaniment through the beat data information, and defining a degree of note coordination of the musical accompaniment through the chord data information under definition of the texture determination rule.

19. The apparatus according to claim 10, wherein:
the melody data information is configured to define a note variation range corresponding to the musical accompaniment through a pitch range, a pitch density, and a pitch value;
the beat data information is configured to determine a rhythm type corresponding to the musical accompaniment through a number of musical beats per unit time; and
the chord data information is configured to assist the melody data information in determining a degree of note coordination through a chord position.

20. The apparatus according to claim 10, wherein the processor, when loading and executing the one or more instructions, is caused to perform:
obtaining a mixing result by performing mixing processing on the melody data information and the musical accompaniment data; and
obtaining a musical result corresponding to the musical data by performing audio data rendering on the mixing result, wherein the musical result uses the musical accompaniment as accompaniment content.
